(19) United States
(12) Patent Application Publication
(10) Pub. No.: US 2018/0283622 A1
(43) Pub. Date: Oct. 4, 2018

(54) Light, Portable Lighting Device and Method

(71) Applicant: Darin Weyand, Elk, WA (US)

(72) Inventor: Darin Weyand, Elk, WA (US)

(21) Appl. No.: 15/474,623

(22) Filed: Mar. 30, 2017

(51) Int. Cl. F21L 4/00; F21V 17/16; F21V 23/06; F21V 21/08; F21V 23/04; A42B 3/04

(52) U.S. Cl. CPC F21L 4/00; F21V 17/16; F21V 23/06; F21Y 2115/10; F21V 23/0414; F21V 23/0407; A42B 3/0446; F21V 21/0832

(57) ABSTRACT

A light is provided having an extensible member of elastic material, at least one lamp, a pair of electrical contacts, at least one electrical lead, and a retention member. The at least one lamp is carried by the extensible member. The pair of electrical contacts is carried in spaced apart relation by the member and is movable between extended and retracted positions responsive to extension and retraction of the extensible member. The at least one electrical lead electrically couples together the at least one lamp and the pair of electrical contacts and is configured to provide an electrical circuit operative to illuminate the lamp when a respective pair of battery contacts are engaged with the electrical contacts. The retention element has an elastic portion provided by the extensible member and a contact portion configured to retain a battery within the extensible member. A method is also provided.

### TECHNICAL FIELD

This disclosure pertains to lights, lighting apparatus and methods. More particularly, this disclosure relates to compact lights and lighting devices and methods.

### BACKGROUND

Techniques are known for providing simple and compact lights. For the case of handheld lights and flashlights, it is known to have housings that accommodate insert members that allow insertion of different sized batteries. However, there exists a need to further improve the manner in which such variously sized batteries are retained in a light, without increasing the number of parts or increasing the weight and complexity. Other lights could further benefit from a solution to this need.

### SUMMARY

A lamp is provided in the form of a portable lighting device having an extensible member of elastic material that enables insertion, retention and removal of a battery between a pair of opposed electrical contacts that are urged into electrical contact with corresponding poles on the battery.

According to one aspect, light is provided having an extensible member of elastic material, at least one lamp, a pair of electrical contacts, at least one electrical lead, and a retention member. The at least one lamp is carried by the extensible member. The pair of electrical contacts is carried in spaced apart relation by the member and is movable between extended and retracted positions responsive to extension and retraction of the extensible member. The at least one electrical lead electrically couples together the at least one lamp and the pair of electrical contacts and is configured to provide an electrical circuit operative to illuminate the lamp when a respective pair of battery contacts are engaged with the electrical contacts. The retention element has an elastic portion provided by the extensible member and a contact portion configured to retain a battery within the extensible member

According to another aspect, a portable lighting device is provided having an elastic band, at least one lamp, a pair of electrical contacts, at least one electrical lead, and a retention element. The at least one lamp is affixed to the elastic band to form a loop. The pair of electrical contacts is carried in spaced apart relation along the loop movable between extended and retracted positions responsive to stretching of the elastic band. The at least one electrical lead electrically couples together the at least one lamp and the pair of electrical contacts and is configured to provide an electrical circuit operative to illuminate the lamp when a respective pair of battery contacts are engaged with the electrical contacts by inserting an elongate battery within the loop while stretching the band, urging the electrical contacts into conductive engagement with the respective battery contacts. The retention element is formed at least in part by the elastic band having an inner surface contact portion configured to retain a battery within the loop.

According to yet another aspect, a method is provided for configuring a battery with a lighting device. The method includes: providing a lighting device having a lamp, a loop of elastic material having an inner contact surface providing a retention member, an opposed pair of electrical contacts, and at least one electrical lead electrically coupling together the pair of electrical contacts and the lamp to form a circuit with opposed electrical contacts on a battery; elongating the loop of elastic material so as to further space apart the electrical contacts; receiving a battery between the further spaced apart and opposed electrical contacts; and releasing the elongated elastic member to entrap and grip the battery within the hoop of the elastic band to entrap the battery between the electrical contacts and retain the battery therein with the contact surface.

### BRIEF DESCRIPTION OF THE DRAWINGS

FIG. 1 is a perspective view illustrating one version of a compact light according to one embodiment.

FIG. 1 is a perspective view from above of one version of a portable lighting device illustrating mounting of the device on a helmet of a bicycle rider according to one embodiment.

FIG. 2 is a perspective view from above illustrating the portable lighting device of FIG. 1 illustrating an elastic feature that enables extensible receipt of a plurality of uniquely differently sized batteries within the portable lighting device.

FIG. 3 is a plan view from above of the portable lighting device of FIG. 2 further illustrating a closed loop configuration of the extensible member or elastic material for the portable lighting device configured prior to receiving an elongate cylindrical battery having positive and negative terminals at opposed ends.

FIG. 4 is a top view of another version of the portable lighting device of FIGS. 1-3 according to another embodiment having a white LED lamp at a front end and a red LED lamp at an opposite end with an on/off switch.

FIG. 5 is a top view of yet another version of the portable lighting device of FIGS. 1-3 according to even another embodiment having a white LED lamp at a front end and a flashing red LED lamp at an opposite end.

FIG. 6 is a perspective view from above of yet even another version of the portable lighting device of FIGS. 1-3 according to yet even another embodiment having an elastic band loop with an transverse elastic retaining band loop.

FIG. 7 is an inner surface partial segment view of the elastic band loop of FIG. 3.

### DETAILED DESCRIPTION OF THE ILLUSTRATED EMBODIMENTS

This disclosure is submitted in furtherance of the constitutional purposes of the U.S. Patent Laws “to promote the progress of science and useful arts” (Article 1, Section 8).

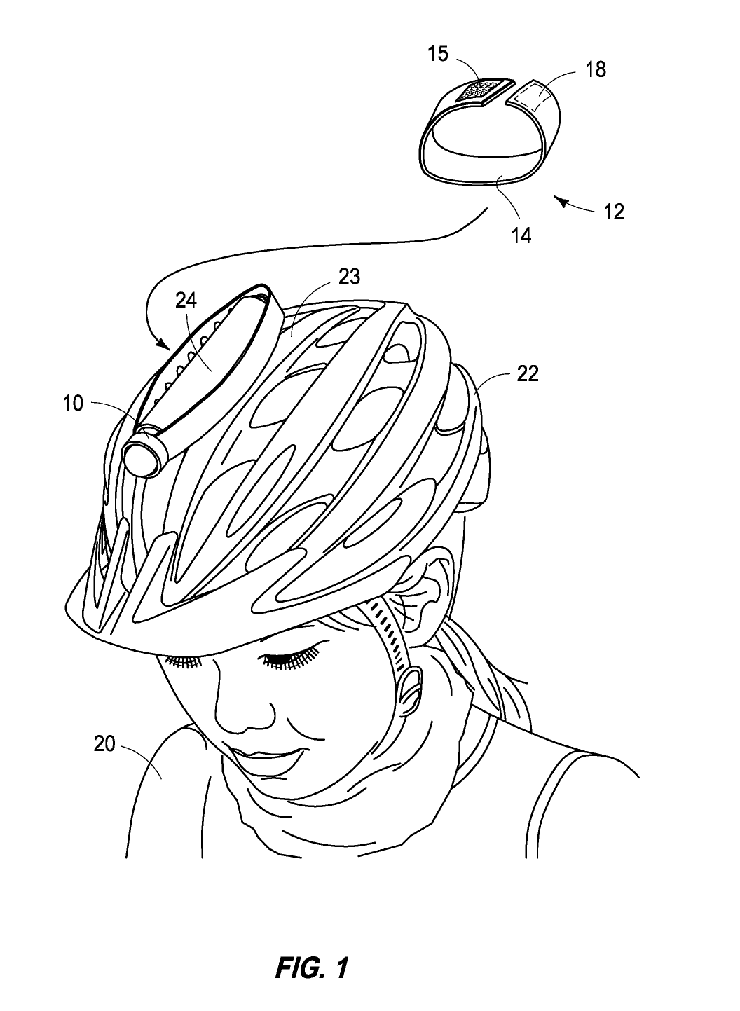

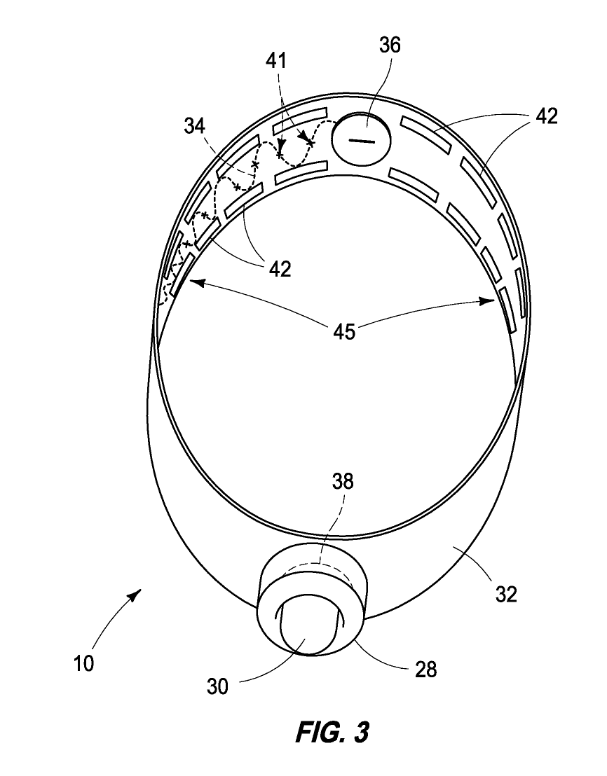

FIG. 1 illustrates a light, or portable lighting device 10 in the form of a helmet mounted light, according to one implementation. Light 10 is extended to a stretched configuration to retain and trap a battery 24 in electrical connection with electrical contacts 36 and 38 (see FIG. 3). Such configuration enables a bicycle rider to see in low light conditions in a manner that provides for hands-free operation. A user 20 is depicted wearing a bicycle helmet 22 that has a longitudinal rib 23 about which a retainer, or hook-and-loop fastener strap 12 is used to removably secure light 10 and mounted battery 24 atop helmet 22. More particularly, retainer 12 includes a nylon strap 14 having a hook fastener 15 and complementary loop faster 18 sewn or affixed at opposed ends. Optionally, any other suitable form of fastener, bracket or attachment device can be provided to affix light 10 atop helmet 22, such as screws, bolts and nuts, clamps, adhesives, and other retention devices.

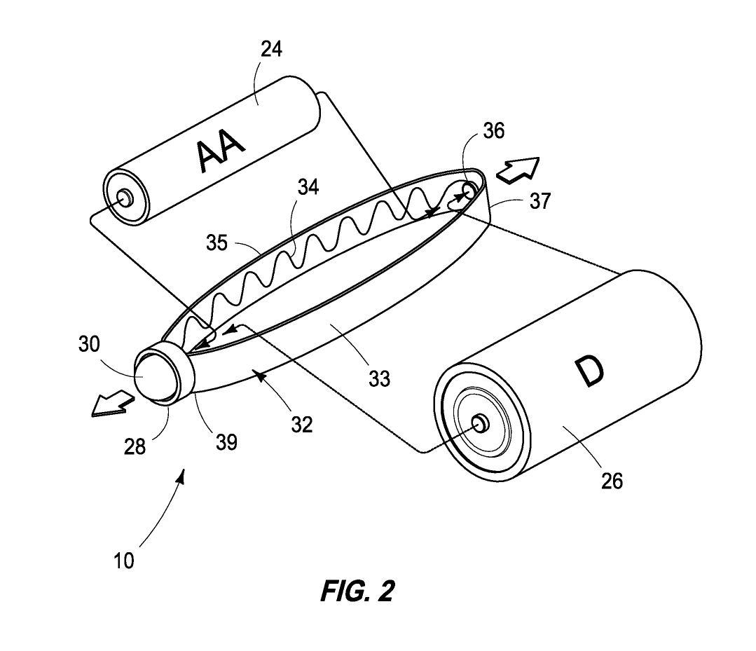

FIG. 2 illustrates one benefit provided by light 10; namely, an ability to interchangeably use light 10 with a plurality of uniquely different sized batteries, such as an AA cell battery 24 and a D cell battery 26. Light 10 includes a light assembly 30 provided in a lamp bezel 28 at a front end 39. An insulated electrical wire, or electrical lead 34 extends in a serpentine pattern from a first electrical contact, such as a positive contact, 38 (see FIG. 3) located at first end 39 to a second electrical contact, such as a negative contact 36 at a second end 37. LED 30 can be interposed along electrical lead 34, between electrical contacts 36 and 38 (see FIG. 3). Optionally, a pair of electrical leads can be used to create an electrical circuit between electrical contacts 36 and 38 and LED 30, in combination with an inserted battery (not shown). Further optionally, electrical contact 38 can be directly connected to LED light 30 and electrical lead 34 also connects directly to LED light 30. Serpentine configuration of wire 34 enables extension and retraction of an extensible retainer 32 to accommodate and retain different unique battery sizes provided by batteries 24 and 26. According to one construction, extensible member 32 is a loop of stretchable elastic webbing configured in a hoop to have opposed lateral elongate sections 33 and 35. However, it is understood that extensible retainer 32 can be formed from one or more segments of stretchable elastic webbing, such as a woven nylon and polyester band, or an elastic or elastomeric material in one of a number of forms including a band, a retainer, a portion, a constituent, a piece, a component, a fragment, a knitted or woven elastic band, a synthetic or natural rubber band, a resistance band and a unit of extensible material capable of being elongated under load and en-shortened when released from load.

As shown in FIGS. 2 and 3, light assembly 30 of light 10 comprises an LED light assembly having a white LED light contained in bezel 28, wherein bezel 28 is secured or affixed to elongated retainer 32 via adhesive, a mechanical fastener, or via elastic stitches. An inner surface 45 of extensible retainer, or elastic band 32 includes an array of discrete, elongate silicon segments 42 affixed to provide frictionable material surfaces along inner surface 45. Optionally, any material having a higher coefficient of friction than a woven elastic band can be used, such as urethane, rubber, synthetic rubber, or use of rubber strands woven into a fabric. Furthermore, dots or serpentine bands or arrays of discrete segments of material, such as silicon can be adhered to an inner surface of band 32. Such segments, along with surface 45 enable gripping of an outer battery surface when received under tension within band 32 to provide retention therein. Optionally, light 10 can comprise any other available color LED light, or a flashing LED light, or a combination thereof.

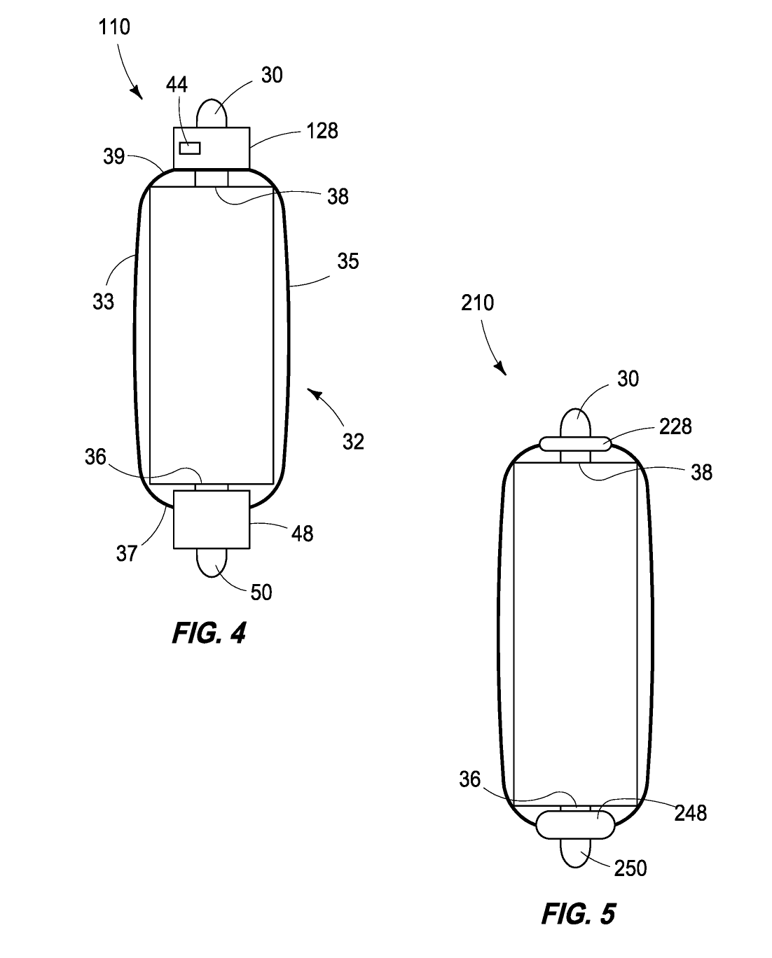

FIG. 4 is a top view of another version portable lighting device 110 according to another embodiment having a white LED lamp 30 at a front end 39 and a red LED lamp 50 at an opposite, rear end 37 with an on/off switch 44 that selectively enables and disables power supply to LED lamps 30 and 50. LED lamp 30 is carried by a lamp bezel 128 with an electrical contact that engages in assembly with a positive battery contact 38 of battery 26. Likewise, LED lamp 50 is carried by a lamp bezel 48 with an electrical contact that engages in assembly with a negative battery contact 36 of battery 26. More particularly, each lamp 30 and 50 has a bezel 128 and 48, respectively, that extends through a hole in the elastic web of extensible retainer 32, and small rivets or fasteners secure each bezel 128 and 48 to the web around the hole. Each respective electrical contact extends through such hole to engage positive and negative contacts 38 and 36, respectively. Legs 33 and 35 of retainer 32 comprise elongate segments of elastic webbing that are stretched to receive and retain battery 26 between lamps 30 and 50 in electrical engagement there between. Insulated electrical wire 30 (see FIG. 3) electrically couples together contacts 36 and 38 to form an electrical circuit with battery 26 to light lamps 30 and 50 when switch 44 is turned to an “on” position, and turn of lamps 30 and 50 when switch 44 is turned to an “off” position.

FIG. 5 is a top view of yet another version portable lighting device 210 according to even another embodiment having a white LED lamp 30 at a front end and a flashing red LED lamp 250 at an opposite end.

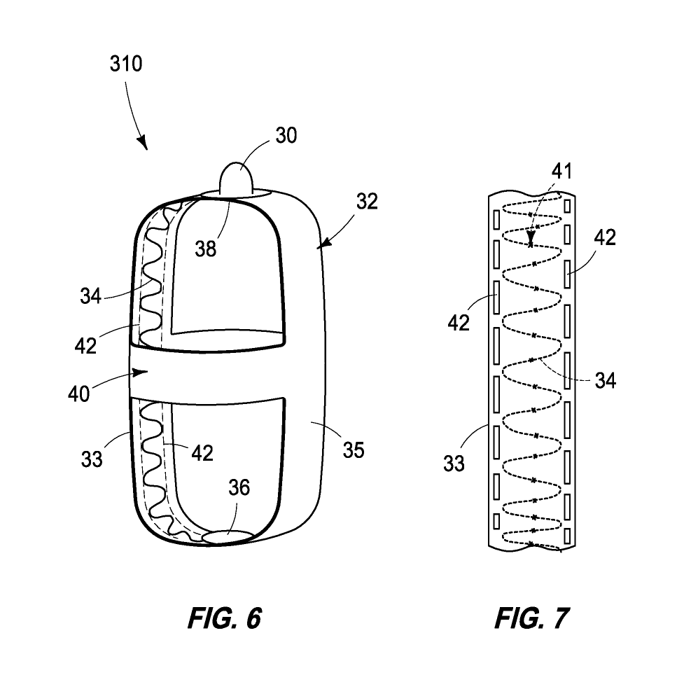

FIG. 6 is a perspective view of yet even another version portable lighting device 310 according to even yet another embodiment having a white LED lamp 30 at a front end and a lateral circumferential retainer, or elastic strap 40 affixed to elongate retainer, or elastic strap 32. According to another construction, strap 40 can be relatively wide, giving the combined configuration of straps 32 and 40 the appearance of a stretchable sock having at least one aperture that enables insertion of a battery. Strap 40 is affixed to strap 32 via stitches (not shown) or via adhesive. Alternatively, strap 40 is integrally formed with strap 32, such as by integral weaving there between. Electrical contacts 36 and 38 are secured to inside surfaces of strap 32 an integral rivet or via adhesive. Strap 40 forms a retention hoop around a battery (received therein) between opposed segments 33 and 35. Individual segments of flexible silicon bead 42 are spaced apart on an inner surface of strap 32 to provide grip and retention against a battery received within strap 32. Insulated electrical wire 34 is configured in a serpentine configuration on an inner surface of segment 33, either by weaving wire 34 within a weave of strap 32, or by using individual stitches to secure wire 34 there along.

FIG. 7 is a partial inside view of a segment of light 10 (of FIG. 3) illustrating an inner surface of the elastic band forming section 33. Individual discrete segments of elastomeric silicon bead 42 are affixed to an inner surface of segment 33 along each lateral edge to provide grip and securement when engaged and stretched along an outer surface of a battery (not shown). Serpentine configuration of insulated electrical wire 34 is also shown affixed with a plurality of stitches using elastic thread such that strap 33 can stretch with serpentine wire 33 flexing to accommodate such extension and retraction of extensible band, or strap 32. Accordingly, the wire 33 within the elastic loop, or strap of segment 33 is configured to allow the strap to stretch with the woven strap material.

Although the above disclosure illustrates embodiments for a portable light, it is understood that such device can be configured with any other form of electrical or electronic device other than an LED light. An incandescent light can be used with the extensible retainer to hold a battery. Similarly, an electronic voice/sound box for a child's stuffed animal can be configured with the extensible retainer to hold a battery inside the stuffed animal. Such construction would reduce the size of a hard casing otherwise used to retain the battery and voice box in the animal, thereby reducing potential hard spots within the stuffed animal that might cause injury if the animal is tossed or thrown during play. Even further electrical and electronic devices can be envisioned which would benefit from using such extensible retainer to hold a power supply, or battery, including AC (with a converter) or DC devices.

In compliance with the statute, the subject matter disclosed herein has been described in language more or less specific as to structural and methodical features. It is to be understood, however, that the claims are not limited to the specific features shown and described, since the means herein disclosed comprise example embodiments. The claims are thus to be afforded full scope as literally worded, and to be appropriately interpreted in accordance with the doctrine of equivalents.

The invention claimed is:

1. A light, comprising:
an extensible member of elastic material;
at least one lamp carried by the extensible member;
a pair of electrical contacts carried in spaced apart relation by the member and movable between extended and retracted positions responsive to extension and retraction of the extensible member;
at least one electrical lead electrically coupling together the at least one lamp and the pair of electrical contacts and configured to provide an electrical circuit operative to illuminate the lamp when a respective pair of battery contacts are engaged with the electrical contacts; and
a retention element having an elastic portion provided by the extensible member and a contact portion configured to retain a battery within the extensible member.

2. The light of claim 1, wherein the extensible member comprises an elastic band having an inner surface that provides the contact portion.

3. The light of claim 1, wherein the retention member comprises a stretchable sock tube having an end pocket with an inner surface that provides at least in part the contact portion.

4. The light of claim 1, wherein the retention member comprises an elongate segment of elastic band and at least one segment of silicon adhered to the contact portion to provide an inner surface of the elongate segment of elastic band.

5. The light of claim 4, wherein the segment of silicon comprises a plurality of beads of silicon adhered to an inner surface of the elongate segment of elastic band.

6. The light of claim 1, wherein the pair of electrical contacts are carried by the extensible member of elastic material in spaced-apart relation to accommodate a plurality of uniquely different sized batteries between the pair of electrical contacts.

7. The light of claim 1, wherein the electrical leads are carried by the extensible member of elastic material in a serpentine pattern that accommodates extension and retraction of the extensible member without restraint of the electrical leads.

8. The light of claim 1, wherein the elastic material is an elastic band, the at least one lamp is an LED lamp affixed to an elongate segment of the elastic band, a first electrical contact is provided on an inner surface of the lamp and a second electrical contact is provided on an inner surface of the elastic band opposite the LED lamp.

9. The light of claim 1, wherein another LED lamp is affixed to the elastic band opposite the one LED lamp, the one LED lamp comprising a white LED front lamp and the other LED lamp comprising a red LED rear lamp, and further comprising a retainer for affixing the light to one of a bicyclist and a bicycle.

10. A portable lighting device, comprising:
an elastic band;
at least one lamp affixed to the elastic band to form a loop;
a pair of electrical contacts carried in spaced apart relation along the loop movable between extended and retracted positions responsive to stretching of the elastic band;
at least one electrical lead electrically coupling together the at least one lamp and the pair of electrical contacts and configured to provide an electrical circuit operative to illuminate the lamp when a respective pair of battery contacts are engaged with the electrical contacts by inserting an elongate battery within the loop while stretching the band, urging the electrical contacts into conductive engagement with the respective battery contacts; and
a retention element formed at least in part by the elastic band having an inner surface contact portion configured to retain a battery within the loop.

11. The portable lighting device of claim 10, wherein the stretchable elastic band comprises a continuous loop of elastic webbing.

12. The portable lighting device of claim 11, wherein the retention element comprises an inner surface of the elastic band.

13. The portable lighting device of claim 12, wherein the retention element further comprises frictionable material adhered to the inner surface of the elastic band.

14. The portable lighting device of claim 13, wherein the frictionable material comprises silicon adhered to an inner surface of the elastic band.

15. The portable lighting device of claim 10, wherein the at least one electrical lead comprises an insulated electrical wire affixed to the elastic band in a serpentine configuration to accommodate elongation of the elastic band.

16. The portable lighting device of claim 15, wherein the elastic band forms a loop configured to encircle and entrap a battery between the pair of electrical contacts in assembly.

17. A method of configuring a battery with a lighting device, comprising:
providing a lighting device having a lamp, a loop of elastic material having an inner contact surface providing a retention member, an opposed pair of electrical contacts, and at least one electrical lead electrically coupling together the pair of electrical contacts and the lamp to form a circuit with opposed electrical contacts on a battery;
elongating the loop of elastic material so as to further space apart the electrical contacts;
receiving a battery between the further spaced apart and opposed electrical contacts; and
releasing the elongated elastic member to entrap and grip the battery within the hoop of the elastic band to entrap the battery between the electrical contacts and retain the battery therein with the contact surface.

18. The method of claim 17, wherein the retention member of the loop comprises a frictionable material, and further comprising gripping the battery by engaging the frictionable material with an outer surface of the battery.

19. The method of claim 18, further comprising a transverse loop portion configured to encircle the battery, and further comprising securing the battery under elastic hoop tension within the transverse loop portion.

20. The method of claim 17, further comprising, after releasing the elongated elastic member, delongating the elastic member to entrap the battery therein.
